(19) United States
(12) Patent Application Publication
(10) Pub. No.: US 2023/0013800 A1
(43) Pub. Date: Jan. 19, 2023

(54) Method for Producing a Bourdon Tube Pressure Gauge

(71) Applicant: Heinz Heller, Rippberg (DE)

(72) Inventor: Heinz Heller, Rippberg (DE)

(21) Appl. No.: 17/786,554

(22) PCT Filed: Dec. 18, 2020
(86) PCT No.: PCT/DE2020/000340

§ 371 Date: Jun. 17, 2022

(30) Foreign Application Priority Data
Dec. 20, 2019 (DE) 10 2019 008 972.3

(51) Int. Cl. G01L 7/04

(52) U.S. Cl. CPC G01L 7/041

(57) ABSTRACT

The invention relates to a method for producing a Bourdon tube pressure gauge 1, comprising at least a housing 2, a Bourdon tube 3 and a process carrier 5, wherein the process medium enters the Bourdon tube 3 via a fluid channel starting from the process carrier 5 and the process carrier 5 is constructed in two parts, wherein a first part is connected to the Bourdon tube 3 as a spring carrier 4 and a second part serves as a connecting element 18 and both parts are joined and connected in the housing 2. In order to enable a low bearing retention, it is provided for the manufacture of a Bourdon tube pressure gauge 1 that the connecting element 18 and/or the spring carrier 4 has a round shoulder 17, 23 and the shoulder 17, 23 is inserted into a radial bore 7 of the housing, wherein first a connection is made between the shoulder 17, 23 of the connecting element 18 and spring carrier 4 and then a connection of the shoulder 17, 23 to the housing 2. Thus, it is possible to provide different connecting elements 18 as well as spring supports 4, which are only assembled and welded together according to the customer's requirements, whereby these are accommodated in a housing 2 and welding to the housing 2 also takes place, so that the Bourdon tube pressure gauge 1 to be finished can be assembled individually in each case.

### CROSS REFERENCE TO RELATED APPLICATIONS

This application is the U.S. national stage of International Application No. PCT/DE2020/000340, filed on 2020 Dec. 18. The international application claims the priority of DE 102019008972.3 filed on 2019-12-20; all applications are incorporated by reference herein in their entirety.

### BACKGROUND

The invention relates to a method for producing a Bourdon tube pressure gauge, comprising at least a housing, a Bourdon tube and a process carrier, wherein the process medium enters the Bourdon tube via a fluid channel starting from the process carrier and the process carrier is designed in two parts, wherein a first part is connected to the Bourdon tube as a spring carrier and a second part serves as a connecting element and both parts are joined and connected in the housing, and to a Bourdon tube manometer.

A Bourdon tube pressure gauge consists of a housing in which a Bourdon tube is located, which is used to control a measuring mechanism with pointer. Bourdon tube pressure gauges are used to indicate the prevailing pressure in a pipeline or a machine arrangement, whereby the process medium to be measured reaches the Bourdon tube and causes the Bourdon tube to be changed with regard to the existing radius of curvature due to the prevailing pressure. The Bourdon tubes are also generally referred to as Bourdon springs and consist, for example, of an approximate three-quarter circle, which is connected at one end to a process carrier and the other end has auxiliary means for connecting a measuring mechanism. The measuring mechanism with pointer is usually set to a value of 0 by means of an adjustment, so that when the Bourdon tube is pressurized with an accompanying expansion of the radius of curvature, the movement occurring at the free end can be transmitted to the pointer via the measuring mechanism. The pointer refers to a scale on which the prevailing pressure can be read. The scale and the Bourdon tube are matched to each other in this case and a pressure indication with high accuracy is ensured.

The Bourdon tube is located inside the housing so that it is protected from external influences, among other things, and the housing also houses the measuring mechanism with pointer and the scale. In order for the Bourdon tube pressure gauge to be connected to a pipeline or to pressure-operated equipment, a connecting element is used, which is preferably threaded outside the housing so that the Bourdon tube pressure gauge can be screwed to the machine or pipeline system. Unfortunately, there are a large number of different diameters for the various piping systems, so that Bourdon tube pressure gauges must be provided for each individual case that have a corresponding threaded connection with a suitable diameter. As a result, a large stock of the most varied types of Bourdon tube pressure gauges is necessary. It has therefore proved expedient to design the process carrier and the connecting element in two parts, so that a combination of the respective individual components on the one hand of the process support with Bourdon tube and on the other hand of the connecting element with different thread types and diameters can be made. This measure can significantly reduce stock-keeping, because the appropriate components, namely the process carrier and the connecting element, are always combined and connected during an order process on the part of a customer. Such a connection includes not only the connection between process carrier and fastener, but also a connection with the housing.

The connection of the three parts, housing, spring carrier and connecting element, is relatively difficult because a connection must be made within the housing and to the housing, and there is a requirement that the Bourdon tube be fixed in a suitable position within the housing.

### SUMMARY

The invention relates to a method for producing a Bourdon tube pressure gauge 1, comprising at least a housing 2, a Bourdon tube 3 and a process carrier 5, wherein the process medium enters the Bourdon tube 3 via a fluid channel starting from the process carrier 5 and the process carrier 5 is constructed in two parts, wherein a first part is connected to the Bourdon tube 3 as a spring carrier 4 and a second part serves as a connecting element 18 and both parts are joined and connected in the housing 2. In order to enable a low bearing retention, it is provided for the manufacture of a Bourdon tube pressure gauge 1 that the connecting element 18 and/or the spring carrier 4 has a round shoulder 17, 23 and the shoulder 17, 23 is inserted into a radial bore 7 of the housing, wherein first a connection is made between the shoulder 17, 23 of the connecting element 18 and spring carrier 4 and then a connection of the shoulder 17, 23 to the housing 2. Thus, it is possible to provide different connecting elements 18 as well as spring supports 4, which are only assembled and welded together according to the customer's requirements, whereby these are accommodated in a housing 2 and welding to the housing 2 also takes place, so that the Bourdon tube pressure gauge 1 to be finished can be assembled individually in each case.

### DETAILED DESCRIPTION

The present invention is therefore based on the task of demonstrating a method which facilitates the assembly and connection of spring carrier, connecting element and housing.

The present invention is further based on the task of disclosing a Bourdon tube pressure gauge which has been manufactured according to the method.

To solve the process task, it is proposed that the connecting element and/or the spring carrier has a round shoulder and the shoulder is inserted into a radial bore of the housing, wherein first a connection is made between the shoulder of the connecting element and spring carrier and then a connection of the shoulder to the housing.

The basic idea of providing a housing with a selected spring carrier with a Bourdon tube and a connecting element with a selected threaded connection can be realized by the process steps shown. Here, the connecting element and the spring carrier, or possibly only one of the two elements, can have a round pin which can be inserted into the radial bore of the housing. With the insertion into the housing, the process carrier with Bourdon tube is initially in a not exactly fixed position with respect to the housing. For this purpose, a connection is first made between the neck of the connecting element and the spring support, preferably by means of a welding operation, more preferably by means of a laser welding operation. Here, it is only necessary to ensure that both the connecting element and the spring carrier are aligned along the longitudinal axis. The shoulder can then be rotated relative to the housing as desired, to a position that allows the bourdon tube to be aligned within the housing, preferably aligned in the plane of the housing. Due to the length of the existing extension, it is possible to make an alignment in depth with respect to the housing, so that a central position of the Bourdon tube within the housing can be achieved and subsequently a connection of the extension with the housing is made.

Particularly noteworthy is that the mounting position can be corrected and aligned via the shoulder before connection to the housing, whereby a flood-tight connection of the Bourdon tube to the spring carrier is made beforehand with the aid of a weld and then connection to the connecting element and later to the housing. The dimensions of the extension and the bore of the housing are matched to each other, so that there is only a small gap between the housing and the extension and a weld can be produced with the aid of a laser. Of course, a flood-tight connection is made primarily between the spring carrier and the Bourdon tube so that the medium to be measured cannot escape. The extension is designed in such a way that the process carrier with Bourdon tube or the connecting element can be moved over a larger area within the bore of the housing.

The essential point of the present invention further consists in the fact that the two joined parts, namely the spring carrier and the connecting element, are axially displaceable relative to the bore of the housing and additionally rotatable. Thus, a connection with the housing is possible after aligning the spring carrier with carrier with respect to the housing both in the plane of the housing and in the distance of the connecting element to the housing. Here, the spring carrier with Bourdon tube is aligned parallel to the housing plane and the spring carrier and the connecting element are axially displaced relative to the housing, preferably displaced and thus aligned.

In order to exclude a lateral offset between the shoulder of the two corresponding parts, namely the process carrier and the connecting element, at least one shoulder has a recess and the corresponding shoulder has an annular protrusion. Both the recess and the annular protrusion serve to facilitate the joining of the two parts and to improve centering before they are welded together.

In order for the process medium to be measured to enter the Bourdon tube, both the connecting element and the spring carrier have a bore which opens into the Bourdon tube, so that after screwing the connecting element into the pipe system or into the mechanical apparatus, the process medium to be measured can enter the Bourdon tube unhindered.

To enable precise adjustment within the housing, taking into account the different spring sizes, a central mounting of the Bourdon tube within the housing is possible, at least one of the shoulders is longer and preferably has a length of more than 5 mm. If necessary, however, both shoulders could also have a greater length, with the length of both shoulders determining the range of movement of the process carrier within the housing.

In a further embodiment of the invention, it is provided that a choke or a filter with a bore of 0.1 mm, 0.2 mm or 0.3 mm is inserted into the bore of the process carrier or the connecting element before welding of both parts. The insertion of a choke, possibly a filter, into the existing bore and subsequent welding, in particular laser welding, ensures that neither the choke nor the filter can fall out of the bores and are thus captive.

The fact that the choke or filter has only a small bore means that it is not possible, for example, for a viscous liquid to run off. It is therefore possible for the entire measuring mechanism to be prefilled with a liquid, including the Bourdon tube. Preferably, a damping fluid is used in this case to avoid shock loading of the pointer, which is connected to the measuring mechanism. In this way, with the aid of the viscous liquid and the damping that occurs, a smooth pointer deflection can be ensured even under shock load.

The holes in the choke or filter prevent the process liquid from flowing out, so that the area from the choke or filter to the spring can already be filled. If necessary, the spring carrier can be provided with an additional hole for this purpose, which is used for filling and is then closed. If a filter is used instead of a choke, or if both elements are used and contamination of the filter unit should occur, pressure could be applied through the reopened filling hole to remove the particles present from the filter.

To solve the device task, a Bourdon tube pressure gauge is provided in which the connecting element and/or the spring carrier has a round extension which can be inserted in a radial bore of the housing, there being a connection between the extension of the connecting element and the spring carrier and a connection of the extension to the housing. Here, the spring carrier with Bourdon tube is aligned parallel to the housing plane and, in addition, the spring carrier and the connecting element are positioned in the axial direction relative to the housing. The projection provided on the process carrier or connecting element brings with it the essential advantage that an easier welding connection between the spring carrier and the connecting element is possible, preferably by means of a laser process, and, in addition, an alignment within the housing is made possible, whereby likewise a connection in the form of a welding with the housing is substantially facilitated, since the projection in the bore located in the housing has only a small gap dimension, which can be completely closed, for example, with the aid of a laser welding. Likewise, of course, a flood-tight connection is made between the spring carrier and the connecting element so that the process medium to be measured enters the Bourdon tube and leakage is prevented. All the connections, i.e., the connection between the spring carrier with the Bourdon tube on the one hand and the spring carrier with the connecting element on the other hand, as well as the subsequent connection with the housing, are made by means of laser welding, whereby no welding agent is used that could lead to corrosion. Instead of laser welding, pulsed TIG welding, plasma welding or electronic beam welding or induction soldering could also be used.

Another welding method is spot welding with electrical charge energy. The capacitor discharge welding process developed by Bokli Bock and Klingenberg GmbH is also ideally suited for welding the housing both to the spring carrier or connecting element. Capacitor discharge welding is a modified resistance welding process characterized by high reproducibility of each weld and only low operating costs. In this case, there is a combination of mechanical pressure and energy through a current flow, with both variables kept constant by control loops. Due to the high energy requirement, a high-power capacitor battery is used, which is previously charged via the mains and a high storage capacity is available for the welding process. Such a high-capacity capacitor bank provides a high welding current, with a voltage of 48 volts capable of delivering up to 1,000 kA. Existing weld puckers provide contact resistance in this case, forcing the flow of energy to this small contact area of the weld. A current density generated in this way causes the weld puck to melt, and the mechanical pressure ultimately ensures a uniform microstructure at the weld joint. In this case, the energy is only effective in the weld zone and only for an extremely short time, so that the surrounding material with its properties is hardly affected. In the event that material-related embrittlement should occur, a defined second pulse can reverse this effect. The advantages of capacitor discharge welding are low energy consumption and simple operation for monitoring the welding quality with displacement, current and force sensors. In addition, quality control and documentation are available at no additional cost. With the aid of an optional heat pulse, it is possible to eliminate existing material stresses. For the aforementioned reasons, this process is equally suitable.

The individual parts of the Bourdon tube pressure gauge are precisely matched to each other in terms of their dimensional accuracy, so that they can be very easily assembled and connected by means of welding.

For better merging and axially symmetrical alignment of spring carrier and fastener, at least one of the shoulders is provided with a recess and the corresponding pin with an annular protrusion, whereby the annular protrusion can be inserted into the recess with a precise fit and thus lateral misalignment between spring carrier and fastener is excluded. The projection is used here for better merging and positioning during the welding process. The finished Bourdon tube pressure gauge has a bore opening into the Bourdon tube, which is guided through the connecting element over the process support to the Bourdon tube. This allows the process medium to be measured to reach the Bourdon tube directly via the threaded connection of the connecting element.

In order to ensure a more varied positioning for mounting the spring carrier in the housing, at least one shoulder has a length of more than 5 mm, whereby it is not excluded that both shoulders of both the spring carrier and the connecting element have a predetermined length which determines the axial travel of the connecting element relative to the housing.

By using an additional choke and/or filter, it is also possible to fill the area from a choke or filter to the Bourdon tube, for example with a viscous liquid that cannot flow off due to the small bore in the choke and filter. In this case, a damping fluid is preferably used to prevent a violent pointer deflection during shock loading.

According to the invention, the Bourdon tube pressure gauge is equipped with two measuring systems, namely a conventional mechanical measuring system with a pointer display and an electronic measuring system with signal output. The sizes of the electronic measuring systems have been reduced considerably in recent years, so that electronic measuring systems can be used reliably with the same or smaller construction volume and can be transmitted to a central control unit with the aid of a bus system, for example, so that any faults can be detected immediately with appropriate programs. The reaction time of existing control units is thereby considerably reduced. While the mechanical measuring unit enables a display of, for example, 0 to 6 bar, the electronic measuring system with a current output of 4 to 20 mA can be used for connection to a monitoring device.

The electronic measuring system is metal-encapsulated and thus waterproof and splashproof. This ensures that the electronic measuring systems function perfectly, regardless of the process sequences in which pressure detection is required. The electronic measuring systems preferably consist of an encoder that supplies an output signal of 4 to 20 mA at 24 volts supply voltage. Such an encoder system is not limited to a specific type of Bourdon tube pressure gauge, but can be used for any type of pressure gauge.

In order to provide an electronic measuring mechanism in a Bourdon tube pressure gauge, it is provided that a pointer shaft of the mechanical measuring mechanism is extended at the rear and has a magnet receptacle for the encoder system. A magnet can be directly connected to the extended pointer shaft, so that the rotary movement of the pointer shaft leads to a rotation of a magnet mounted on the extended pointer shaft, with magnetic field-sensitive sensors, for example a Hall or XMR sensor, precisely detecting the rotary movement of the magnet in order to convert it into a proportional signal with the aid of the encoder system. The resulting output signal is transmitted to the corresponding monitoring equipment, thus enabling electronic measurement recording. In order to integrate the encoder system into the manometer or to connect it to the manometer, the housing has a rear electronics housing for the encoder system, which is metallically encapsulated, resulting in a waterproof and splashproof design.

The advantages of the present invention are that with the aid of the method and the design of the spring carrier as well as the connecting element, a much easier assembly of both the spring carrier and the connecting element is possible, which is improved by the fact that, for example, one of the shoulders has a recess and the corresponding shoulder has an annular protrusion. The connection between the spring carrier and the connecting element, which is intended for screwing to the piping system or possibly to a machine, enables lower stock-keeping, since a combination between the spring carrier with Bourdon tube and the matching thread of the connecting element can always be selected, and the welding of both components takes place when one of the shoulder is guided through the existing bore of the housing. Due to the length of the extension, it is possible to push the combination of spring carrier and connecting element so far out of the housing through the existing bore that a simple welding, preferably laser welding, can take place and then an adjustment of the Bourdon tube with spring carrier is carried out inside the housing in order to then also connect the housing with an extension by a welding, preferably laser welding. By specifying this sequence and the fixed connection between the individual components of the Bourdon tube pressure gauge, a stable unit is created here, which can be combined in a corresponding customer request, so that one and the same Bourdon tube with spring carrier can be combined with different connecting elements and delivered.

### BRIEF DESCRIPTION OF THE DRAWINGS

The invention is further explained with reference to the figures.

It shows

FIG. 1 the individual components of a Bourdon tube pressure gauge in a perspective exploded view,

FIG. 2 the assembled Bourdon tube pressure gauge in a perspective view,

FIG. 3 the Bourdon tube pressure gauge according to FIG. 2 in a sectional top view, with a cut in the plane of the housing and a process carrier,

FIG. 4 the Bourdon tube pressure gauge according to FIG. 2 in a perspective sectional view, with a cut perpendicular to the plane of the housing and a process carrier

FIG. 5 the Bourdon tube pressure gauge according to FIG. 1 in an intermediate step during production and

FIG. 6 the housing with flanged electronic measuring system.in a perspective, partly cut view.

### DETAILED DESCRIPTION OF THE PREFERRED EMBODIMENTS

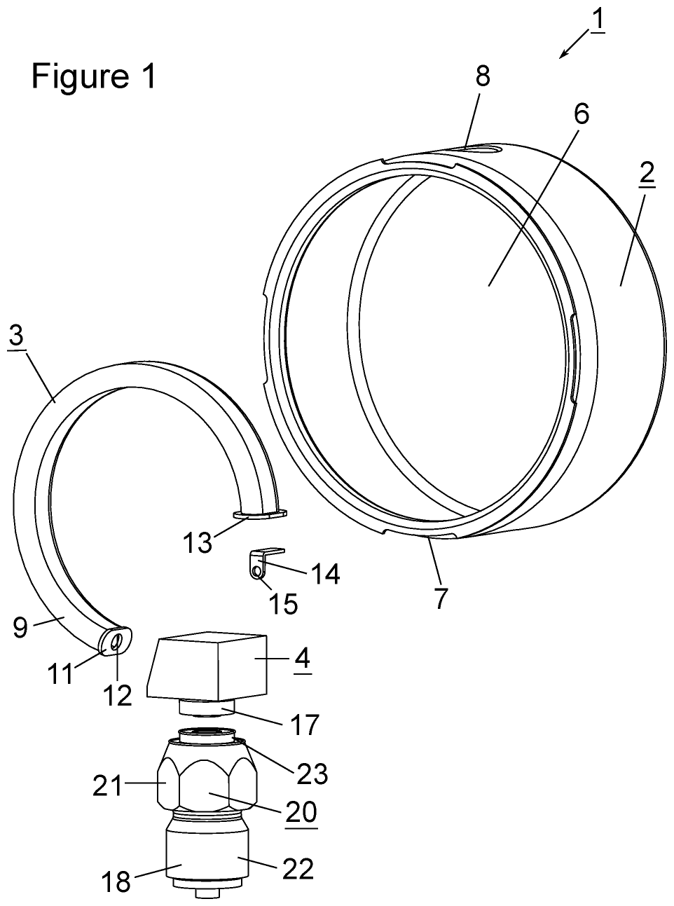

FIG. 1 shows a perspective exploded view of a Bourdon tube pressure gauge 1, consisting of a housing 2, a Bourdon tube 3 and a process carrier 5, which consists of a spring carrier 4 and a connecting element 18.

The housing 2 consists of a round pot-shaped housing part with a bottom 6 and an open front view, which can be closed by means of a cover (not shown) in the form of a frame and a glass pane. The housing 2 has a first bore 7 for the process carrier 5 and a second step bore 8 for a possible evacuation process. The step bore 8 is closed by a plug which is not shown, while the bore 7 is completely sealed airtight after insertion of the process carrier 5 with subsequent welding.

The Bourdon tube 3 has an approximately rectangular cross-section with rounded narrow sides 9, 10. A first end of the Bourdon tube 3 is provided with a connection plate 11, which has a bore 12 to allow the process medium to enter the Bourdon tube 3. The process medium is supplied via the process carrier 5 and the spring carrier 4. The second end of the Bourdon tube 3 is provided with an end plate 13, on which an angle plate 14 with a bore 15 is also provided, the measuring unit, which is not shown, being connected via the bore 15. In this way, a change in the curvature of the Bourdon tube 3 can be detected and transmitted via the measuring mechanism to a pointer (not shown).

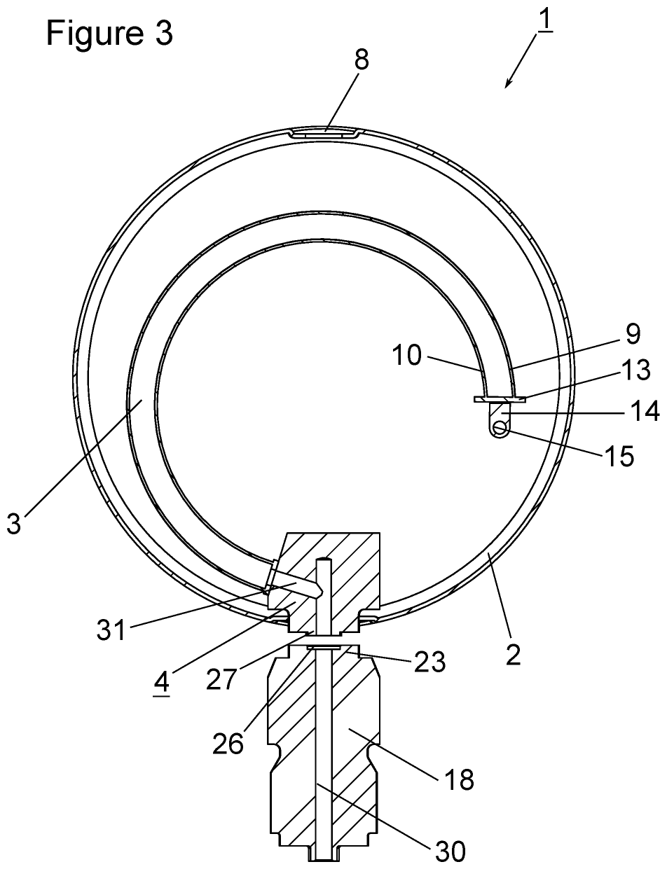

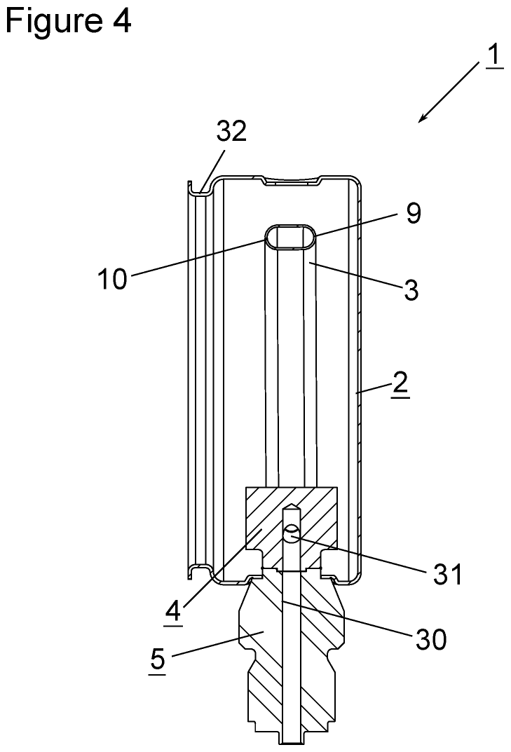

The spring carrier 4 has an approximately cuboid shape, but may deviate from this in individual cases. A beveled surface 16 serves for contact and for welding with the connection plate 11 of the Bourdon tube 3. In addition, the spring carrier 4 is provided with an annular shoulder 17, which is provided for connection with the connecting element 18. A bore extends through both the connecting element 18 and the spring carrier 4, as can be seen, for example, from FIGS. 3 and 4. A hexagonal section 20 of the connecting element 18 has outer surfaces 21 for screwing the connecting element 18 into an existing pipeline by means of an open-end wrench. A round projection 22 of the connecting element 18 is provided with a thread, which can be designed with different threads according to the customer's requirements, which is provided for a fixed screw-in connection with the pipelines. Above the hexagonal section 20, there is an annular shoulder 23 in which a bore 24 is located. As can be seen from FIGS. 3 and 4, the bore 24 extends through the entire connecting element 18 and serves as a supply of the process medium. The bore 24 opens into the spring carrier 4, which also has a bore, so that there is a direct connection to the Bourdon tube 3. Both the spring carrier 4 and the connecting element 18 are provided with an annular shoulder 17, 23, which have approximately the same diameter.

The shoulder 23 of the connecting element 18 also has a recess 26 which corresponds with a protrusion 27 of the spring carrier 4 below. The protrusion is not visible in this illustration, but it engages precisely in the annular recess 26 during assembly. After joining the connecting element 18 and the spring carrier 4, the connecting element 18 and the spring carrier 4 are welded together to form a one-piece assembly.

This method was chosen in the present case so that an already completed spring carrier 4 with Bourdon spring 3 can be connected to any desired connection in the form of the connecting element 18. For this purpose, the connecting element 18 has a threaded connection which may have a different diameter depending on the application, but which is generally standardized. By subsequently connecting the connecting element 18 and spring carrier 4, an individual combination can thus be produced when an order is placed, which can significantly reduce the amount of stock held. In this case, the welding of connecting element 18 and spring carrier 4 is not carried out until the annular shoulder 17 of the spring carrier has been passed through the bore 7 of the housing 2. After welding has taken place, there is a firm connection between process carrier 5 and spring carrier 4 with Bourdon spring 3. Welding to the housing 2 then takes place, whereby alignment of the Bourdon spring 3 within the housing 2 is possible both in the plane and in a coaxial position to the housing 2. For this purpose, the shoulder 17 of the spring carrier 4 and the shoulder 23 of the connecting element 18 are used, which offer the possibility of rotating and displacing the connecting element 18 relative to the housing 2 together with the spring carrier 4 and the Bourdon spring 3. After the desired position has been determined, either the annular shoulder 17 of the spring carrier 4 or the annular recess 25 of the connecting element 18 is welded to the housing 2. The advantage of this subsequent welding is that a desired alignment of the Bourdon spring can be made within the housing, whereby the respective components of a Bourdon tube manometer 1 are for the most part prefabricated and individually combined and welded with a connecting element 18 in accordance with the customer's wishes, so that stockkeeping can be significantly reduced.

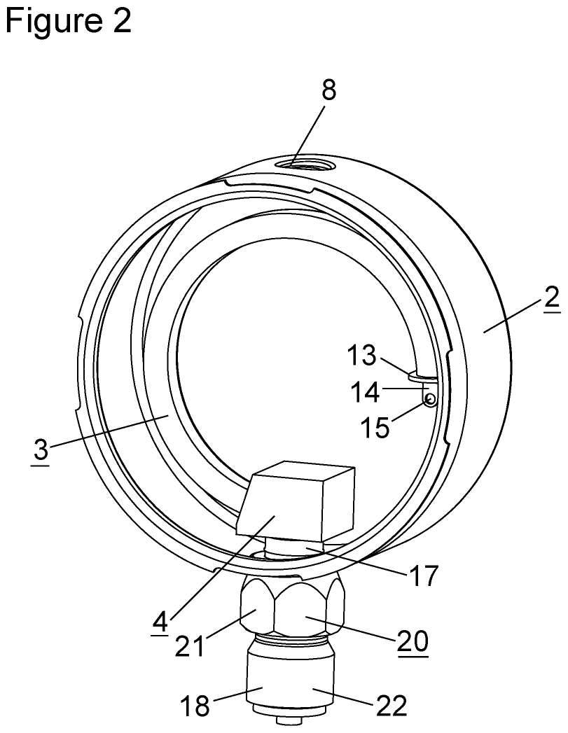

FIG. 2 shows a perspective view of the pressure gauge 1 after the connecting element 18, 5, spring carrier 4 and Bourdon spring 3 have been joined and welded to the housing 2. As a result of the welding to the shoulder 17 or 23 of the spring carrier or connecting element 18, the housing 2 is completely sealed in the area of the connecting element 18, while the upper step bore 8 must be closed by a plug. The Bourdon spring 3 is inserted centrally inside the housing 2 and is locked by the welding. For this purpose, it is only necessary to install the measuring mechanism in the housing 2 and to fit a lockable cover, so that the Bourdon tube pressure gauge 1 is completed.

FIG. 3 shows a sectional view of the Bourdon tube pressure gauge 1, with the cut running in the plane of the housing 2 through the connecting element 18. For this reason, the connecting element 18 can be seen with a bore 30, which opens into the spring carrier 4. A further bore 31 is present in the spring carrier 4, so that the process medium to be measured enters the Bourdon spring 3 directly via the bores 30, 31. The Bourdon tube 3 consists of a tube which, in the example shown, has an almost rectangular cross-section with rounded narrow sides 9, 10. The Bourdon tube 3 is also welded to the spring carrier 4 and has at the other end an end plate 13 with an angle plate 14, which has a bore 15 for connection to a measuring unit not shown. In this case, the connection is made purely mechanically so that the movement can be transmitted to the measuring mechanism through the curvature of the Bourdon tube 3, and the pointer movement is realized with a corresponding transmission.

FIG. 4 shows a further perspective sectional view of the Bourdon tube pressure gauge 1, and this time the section runs perpendicular to the plane of the housing 2 through which the connecting element 18 passes. In this respect, the bore 30 of the process support is visible and the bore 31 of the spring support 4 only through a small incision. From this view, the shape of the Bourdon tube 3 is once again apparent, with an almost rectangular cross-section, the narrow sides 9, 10 being rounded. From this view it can further be seen that the housing 2 is completely flat and closed in the rear area, while in the front area it has a U-shaped recess 32 for closing with a glass-shaped cover, into which, for example, a sealing element can be inserted.

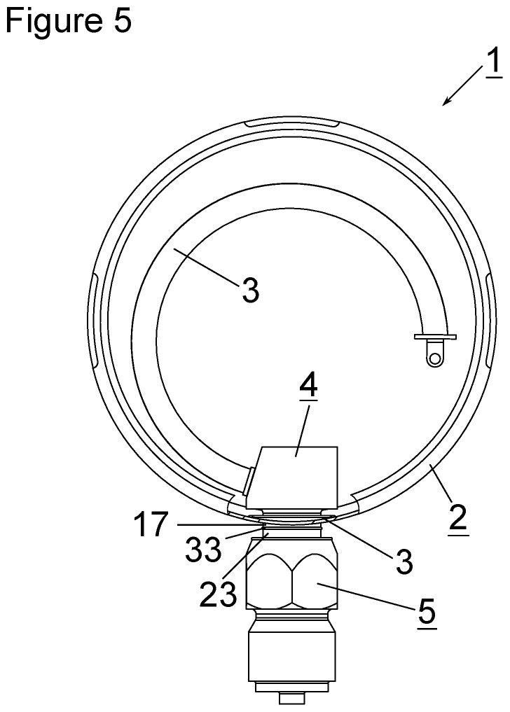

FIG. 5 shows a perspective view of the Bourdon tube pressure gauge 1 with housing 2, spring carrier 3 with Bourdon spring 3 and the connecting element 18. In this case, the first work step for assembling the Bourdon tube pressure gauge 1 is shown, namely a welding of the spring carrier 4 to the connecting element 18 via a weld seam 33. Once welding has been carried out, which is preferably a laser welding operation, the annular shoulder 17 of the spring carrier 4 and the annular shoulder 23 of the connecting element 18 can thus be displaced within the bore 7 of the housing 2. Likewise, a rotation is possible, so that a centric alignment of the Bourdon spring 3 within the housing 2 can take place, whereby likewise an alignment to the plane of the housing 2 is possible. After the fastening element 18 has been fixed relative to the housing 2, both components can thus be welded together so that the lower bore 7 is not only completely closed, but also offers the possibility of aligning the Bourdon spring 3 by means of the two annular shoulders 17 and 23.

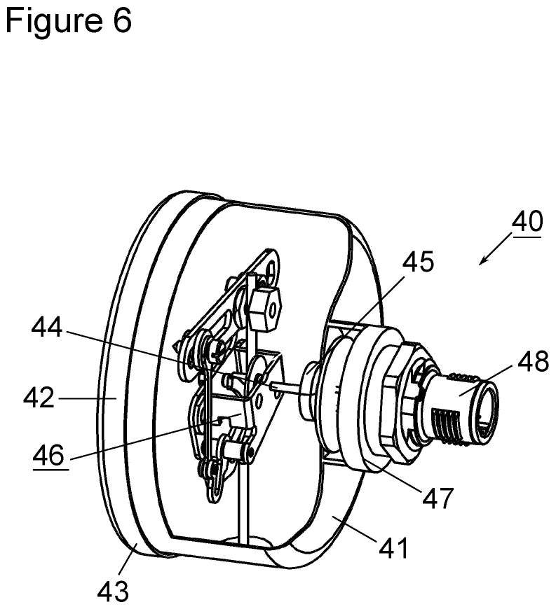

FIG. 6 shows a partially cut perspective rear view of a pressure gauge 40. The housing 41 with Bourdon spring corresponds largely to the design shown in FIGS. 1 to 5. The housing 41 is closed by a cover 42 provided with a glass pane, the cover 42 being firmly seated on the housing 41 with the aid of a circumferential collar 43. A measuring unit 46 is located in the housing 41. In the rear area of the housing 41, a round flange 47 is formed on the housing 41, which is provided to accommodate an electronic measuring system. The only difference between the measuring unit 46 and known embodiments is that the pointer shaft 44 is extended and fitted at the end with a magnet 45. The magnet 45 thus rotates in proportion to the movement of the pointer shaft 44 and causes a magnetic field change in the electronic measuring system, which can be detected with the aid of magnetic field sensors and thus the angle of rotation of the pointer shaft 44 can be determined. The angle of rotation is converted proportionally into a voltage or current signal, which is forwarded to a monitoring direction via a connector plug 48 located at the end.

The embodiment thus discloses a pressure gauge 40 having both a mechanical measuring unit 46 and an electronic measuring mechanism.

### LIST OF REFERENCE NUMERALS

1 Bourdon tube pressure gauge

2 Housing

3 Bourdon tube

4 Spring carrier

5 Process carrier

6 Bottom

7 Bore

8 Step bore

9 Narrow side

10 Narrow side

11 Connection plate

12 Bore

13 End plate

14 Angle plate

15 Bore

16 Surface

17 Shoulder

18 Connecting element

20 Hexagonal section

21 Outer surface

22 Projection/threaded projection

23 Shoulder

24 Bore

25 Annular recess

26 Recess

27 Protrusion

31 Bore

32 Recess

33 Weld seam

40 Pressure gauge

41 Housing

42 Cover

43 Collar

44 Pointer shaft

45 Magnet

46 Measuring unit

47 Flange

48 Connector plug

1. Method for producing a Bourdon tube pressure gauge (1), comprising at least one housing (2, 41), a Bourdon tube (3) and a process carrier (5), the process medium being introduced into the Bourdon tube (3) via a fluid channel starting from the process carrier (5), and the process carrier (5) being designed in two parts, a first part being connected to the Bourdon tube (3) as a spring carrier (4) and a second part serving as a connecting element (18), and the two parts being joined together and connected in the housing (2, 41),
characterized in that
the connecting element (18) and/or the spring carrier (4) have a round shoulder (17, 23) and the shoulder (17, 23) is introduced into a radial bore (7) of the housing (2), a connection first being produced between the shoulder (17, 23) of the connecting element (18) and spring carrier (4) and then a connection of a shoulder (17, 23) to the housing (2, 41).

2. Method according to claim 1,
characterized in that
the two joined parts, namely the spring carrier (4) and the connecting element (18), are axially displaceable and rotatable relative to the bore (7) of the housing (2, 41) and a connection with the housing (2, 41) takes place after the alignment of the spring carrier (4) with the Bourdon tube (3) relative to the housing (2, 41) both in the plane of the housing and in the distance of the connecting element (18) from the housing (2, 41).

3. Method according to claim 1,
characterized in that
the spring carrier (4) with Bourdon tube (3) is aligned parallel to the plane of the housing, and/or that the spring carrier (4) and the connecting element (18) are aligned in the axial direction relative to the housing (2,41).

4. Method according to claim 1,
characterized in that
one of the shoulders (17, 23) has a recess (26) and the corresponding shoulder (17, 23) has an annular protrusion (27).

5. Method according to claim 1,
characterized in that
the shoulders (17, 23) have a bore opening into the spring carrier (4) and the Bourdon tube (3), and/or in that at least one shoulder (17, 23) has a length of more than 5 mm.

6. Method according to claim 1,
characterized in that
a choke or a filter with a bore (7, 12, 15, 24, 31, 32) of 0.1 mm, 0.2 mm or 0.3 mm is inserted into the bore (30, 31) of the process carrier (5) or the connecting element (18) before the welding of both parts.

7. Bourdon tube pressure gauge (1) according to method claim 1, consisting of at least one housing (2, 41), a Bourdon tube (3) and a process carrier (5), the process carrier (5) being designed in two parts, a first part being connected to the Bourdon tube (3) as a spring carrier (4) and a second part serving as a connecting element (18), and the two parts being joined together and connected in and to the housing (2, 41),
characterized in that
the connecting element (18) and/or the spring carrier (4) has a round shoulder (17, 23) and the shoulder (17, 23) can be inserted into a radial bore (7) of the housing (2, 41), there being a connection between the shoulder (17, 23) of the connecting element (18) and spring carrier (4) and a connection of a shoulder (17, 23) to the housing (2, 41), the spring carrier (4) with Bourdon tube (3) being aligned parallel to the plane of the housing and the spring carrier (4) and the connecting element (18) being aligned in the axial direction relative to the housing (2, 41).

8. Bourdon tube pressure gauge (1) according to claim 7,
characterized in that
all connections are made by laser welding and/or that one of the shoulders has a recess (26) and the corresponding shoulder (17, 23) has an annular protrusion (27).

9. Bourdon tube pressure gauge (1) according to claim 7,
characterized in that
the shoulder (17, 23) has a bore (30, 31) opening into the spring carrier (4) and the Bourdon tube (3), and/or in that at least one shoulder (17, 23) has a length of more than 5 mm.

10. Bourdon tube pressure gauge (1) according to claim 7,
characterized in that
a choke or a filter with a bore of 0.1 mm, 0.2 mm or 0.3 mm is inserted into the bore (30, 31) of the process carrier (5) or of the connecting element (18), and/or in that the process carrier (5) has a bore for filling with a viscous liquid.

11. Bourdon tube pressure gauge (1) according to claim 7,
characterized in that
the Bourdon tube pressure gauge (1) is equipped with a second electronic measuring unit (46) which is provided with a current output of 4 to 20 mA for connection to a monitoring device.

12. Bourdon tube pressure gauge (1) according to claim 7,
characterized in that
the electronic measuring system is metallically encapsulated and thus waterproof and splashproof, and/or that the electronic measuring system consists of an encoder.

13. Bourdon tube pressure gauge (1) according to claim 7,
characterized in that
the encoder system can be used for plate springs, Bourdon tubes, capsule springs, absolute measuring instruments, differential pressure measuring instruments, mechanical force transducers, mechanical temperature measuring instruments and rail vehicles.

14. Bourdon tube pressure gauge (1) according to claim 7,
characterized in that
the pointer shaft of the measuring unit (46) is extended at the rear and has a magnet receptacle for the encoder system.

15. Bourdon tube pressure gauge (1) according to claim 7,
characterized in that
a magnet is arranged on the extended pointer shaft.
